(19) United States
(12) Patent Application Publication
(10) Pub. No.: US 2013/0343356 A1
(43) Pub. Date: Dec. 26, 2013

(54) METHOD AND APPARATUS FOR CONFIGURATION OF SPECIAL SUBFRAME PATTERN CONFIGURATION

(71) Applicants: Wei Bai, Beijing (CN); Jing Han, Beijing (CN); Erlin Zeng, Beijing (CN); Na Wei, Beijing (CN); Chunyan Gao, Beijing (CN); Haiming Wang, Beijing (CN); Wei Hong, Beijing (CN)

(72) Inventors: Wei Bai, Beijing (CN); Jing Han, Beijing (CN); Erlin Zeng, Beijing (CN); Na Wei, Beijing (CN); Chunyan Gao, Beijing (CN); Haiming Wang, Beijing (CN); Wei Hong, Beijing (CN)

(73) Assignee: RENESAS MOBILE CORPORATION, Tokyo (JP)

(21) Appl. No.: 14/003,625

(22) PCT Filed: Mar. 9, 2011
(86) PCT No.: PCT/CN2011/071632

§ 371 Date: Sep. 6, 2013

(51) Int. Cl. H04W 72/04

(52) U.S. Cl. CPC H04W 72/0446
USPC 370/336

(57) ABSTRACT

A method is provided for configuration of a special subframe pattern configuration. The method may include determining a configuration of a primary special subframe pattern configuration. The first special subframe configuration may have a corresponding secondary special subframe pattern configuration for multiplexing with the primary special subframe pattern configuration. The method may further include, responsive to a downlink assignment following the configuration of the primary special subframe pattern configuration, using the secondary special subframe pattern configuration instead of the primary special subframe pattern configuration. A corresponding apparatus and computer program product are also provided.

### TECHNOLOGICAL FIELD

Embodiments of the present invention relate generally to wireless communication technology and, more particularly, relate to an apparatus, method and computer program product for configuration of a special subframe pattern configuration.

### BACKGROUND

Wireless and mobile networking technologies have been developing at a rapid pace. Driven by consumer demand, and fueled by continuous advances in battery technology and the ability to manufacture small and highly capable devices, many advancements have also been made in relation to the production of devices that utilize these developing technologies. These devices are becoming ubiquitous in the modern world and are increasingly being employed for use in communication, gaming, social networking, content generation, content sharing, scheduling and numerous other activities.

As an example, advanced wireless networking technologies, such as Long Term Evolution Advanced (LTE-A), that offer enhanced services by means of higher data rate and lower latency are being developed and deployed. However, advanced wireless networking technologies are often deployed in a common operation area with legacy systems, such as Time Division Synchronous Code Division multiple Access (TD-SCDMA) systems. In such instances where an advanced and a legacy wireless networking technology are co-deployed, care must be taken to ensure that concurrent operation of multiple wireless networking technologies in the shared operation area does not result in interference. In this regard, advanced and legacy wireless networking technologies may operate using common and/or adjacent frequency bands. As such, care must be taken to ensure that there is not overlap between uplink and downlink periods of the co-deployed wireless networking technologies. One technique to avoid such uplink/downlink interference is to select a special subframe configuration for usage by user equipment (UE) in an advanced wireless networking technology, such as LTE-A, so that communications by the UE does not interfere with communications using the legacy wireless networking technology.

### BRIEF SUMMARY OF EXAMPLE EMBODIMENTS

A method, apparatus and computer program product are provided herein for configuration of a special subframe pattern configuration. For example, some example embodiments may advantageously enable configuring a UE to use a special subframe pattern configuration offering an extended downlink pilot time slot that may be used for additional data reception by the UE without causing uplink/downlink interference to operation of a co-deployed legacy wireless networking technology. Further, some such example embodiments may be backwards compatible for use in a network environment in which one or more legacy UEs, which may not be configured in accordance with an example embodiment disclosed herein, may access the same network as a UE configured in accordance with an example embodiment disclosed herein. Additionally, some example embodiments may allow for special subframe pattern configuration using relatively little signaling overhead compared to other signaling methods, such as radio resource control signaling.

In a first example embodiment, a method is provided, which may comprise determining a configuration of a primary special subframe pattern configuration. The primary special subframe pattern configuration of this example embodiment may have a corresponding secondary special subframe pattern configuration configured for multiplexing with the primary special subframe pattern configuration. The method of this example embodiment may further comprise, responsive to a downlink assignment following the configuration of the primary special subframe pattern configuration, using the secondary special subframe pattern configuration instead of the primary special subframe pattern configuration.

In another example embodiment, an apparatus comprising processing circuitry is provided. The processing circuitry of this example embodiment may be configured to at least determine a configuration of a primary special subframe pattern configuration. The primary special subframe pattern configuration of this example embodiment may have a corresponding secondary special subframe pattern configuration configured for multiplexing with the primary special subframe pattern configuration. The processing circuitry of this example embodiment may be further configured, responsive to a downlink assignment following the configuration of the primary special subframe pattern configuration, to use the secondary special subframe pattern configuration instead of the primary special subframe pattern configuration.

In another example embodiment, a computer program product comprising at least one computer-readable storage medium having computer-readable program code instructions stored therein is provided. The computer-readable program code instructions may include program code instructions configured to cause an apparatus to perform a method. The method of this example embodiment may comprise determining a configuration of a primary special subframe pattern configuration. The primary special subframe pattern configuration of this example embodiment may have a corresponding secondary special subframe pattern configuration configured for multiplexing with the primary special subframe pattern configuration. The method of this example embodiment may further comprise, responsive to a downlink assignment following the configuration of the primary special subframe pattern configuration, using the secondary special subframe pattern configuration instead of the primary special subframe pattern configuration.

In another example embodiment, an apparatus is provided, which may comprise means for determining a configuration of a primary special subframe pattern configuration. The primary special subframe pattern configuration of this example embodiment may have a corresponding secondary special subframe pattern configuration configured for multiplexing with the primary special subframe pattern configuration. The apparatus of this example embodiment may further comprise means for, responsive to a downlink assignment following the configuration of the primary special subframe pattern configuration, using the secondary special subframe pattern configuration instead of the primary special subframe pattern configuration.

In another example embodiment, a method is provided, which may comprise causing broadcast of a primary special subframe pattern configuration. The primary special subframe pattern configuration of this example embodiment may have a corresponding secondary special subframe pattern configuration configured for multiplexing with the primary special subframe pattern configuration. The method of this example embodiment may further comprise, following broadcast of the primary special subframe pattern configuration, causing signaling of a downlink assignment to a user equipment to trigger the user equipment to use the secondary special subframe pattern configuration instead of the primary special subframe pattern configuration.

In another example embodiment, an apparatus comprising processing circuitry is provided. The processing circuitry of this example embodiment may be configured to at least cause broadcast of a primary special subframe pattern configuration. The primary special subframe pattern configuration of this example embodiment may have a corresponding secondary special subframe pattern configuration configured for multiplexing with the primary special subframe pattern configuration. The processing circuitry of this example embodiment may be further configured, following broadcast of the primary special subframe pattern configuration, to cause signaling of a downlink assignment to a user equipment to trigger the user equipment to use the secondary special subframe pattern configuration instead of the primary special subframe pattern configuration.

In another example embodiment, a computer program product comprising at least one computer-readable storage medium having computer-readable program code instructions stored therein is provided. The computer-readable program code instructions may include program code instructions configured to cause an apparatus to perform a method. The method of this example embodiment may comprise causing broadcast of a primary special subframe pattern configuration. The primary special subframe pattern configuration of this example embodiment may have a corresponding secondary special subframe pattern configuration configured for multiplexing with the primary special subframe pattern configuration. The method of this example embodiment may further comprise, following broadcast of the primary special subframe pattern configuration, causing signaling of a downlink assignment to a user equipment to trigger the user equipment to use the secondary special subframe pattern configuration instead of the primary special subframe pattern configuration.

In another example embodiment, an apparatus is provided, which may comprise means for causing broadcast of a primary special subframe pattern configuration. The primary special subframe pattern configuration of this example embodiment may have a corresponding secondary special subframe pattern configuration configured for multiplexing with the primary special subframe pattern configuration. The apparatus of this example embodiment may further comprise means for, following broadcast of the primary special subframe pattern configuration, causing signaling of a downlink assignment to a user equipment to trigger the user equipment to use the secondary special subframe pattern configuration instead of the primary special subframe pattern configuration.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates an example of a compatibility requirement for co-deployed wireless networking technologies;

FIG. 2 illustrates an example of resources that may be wasted by some special subframe pattern configurations;

FIG. 3 illustrates an example communication system according to some example embodiments;

FIG. 4 illustrates a block diagram of a user equipment in accordance with some example embodiments;

FIG. 5 illustrates a block diagram of an access point in accordance with some example embodiments;

FIG. 6 illustrates an example cell reference signal pattern for a single antenna port;

FIG. 7 illustrates an example of cross carrier scheduling when carrier aggregation is configured in accordance with some example embodiments;

FIG. 8 illustrates a flowchart according to an example method for configuration of a special subframe pattern configuration according to some example embodiments;

FIG. 9 illustrates a flowchart according to another example method for configuration of a special subframe pattern configuration according to some example embodiments;

FIG. 10 illustrates a flowchart according to a further example method for configuration of a special subframe pattern configuration according to some example embodiments; and

FIG. 11 illustrates a flowchart according to yet another example method for configuration of a special subframe pattern configuration according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media) and transmission media. Transmission media include, for example, coaxial cables, copper wire, fiber optic cables, and carrier waves that travel through space without wires or cables, such as acoustic waves and electromagnetic waves, including radio, optical and infrared waves. Examples of computer-readable storage media include optical computer-readable storage media (e.g., optical discs), magnetic storage media (e.g., a hard disk), a random access memory (RAM), a programmable read only memory (PROM), flash memory, any other memory chip or cartridge, or any other medium from which a computer can read. The term computer-readable storage medium (e.g., a non-transitory computer-readable medium) is used herein to refer to any computer-readable medium except a carrier wave or other transmission media. However, it will be appreciated that where embodiments are described to use a computer-readable storage medium, other types of computer-readable mediums may be substituted for or used in addition to the computer-readable storage medium in alternative embodiments.

In some instances, a wireless networking technology, such as time division duplex (TDD) LTE, may be co-deployed with a legacy wireless networking technology, such as TD-SCDMA, in a shared operation area. In such instances, the TDD LTE system should be compatible with the TD-SCDMA system to avoid uplink (UL)/downlink (DL) interference. In this regard, there should not be overlap between UL and DL, even when different frequencies are used by the two systems.

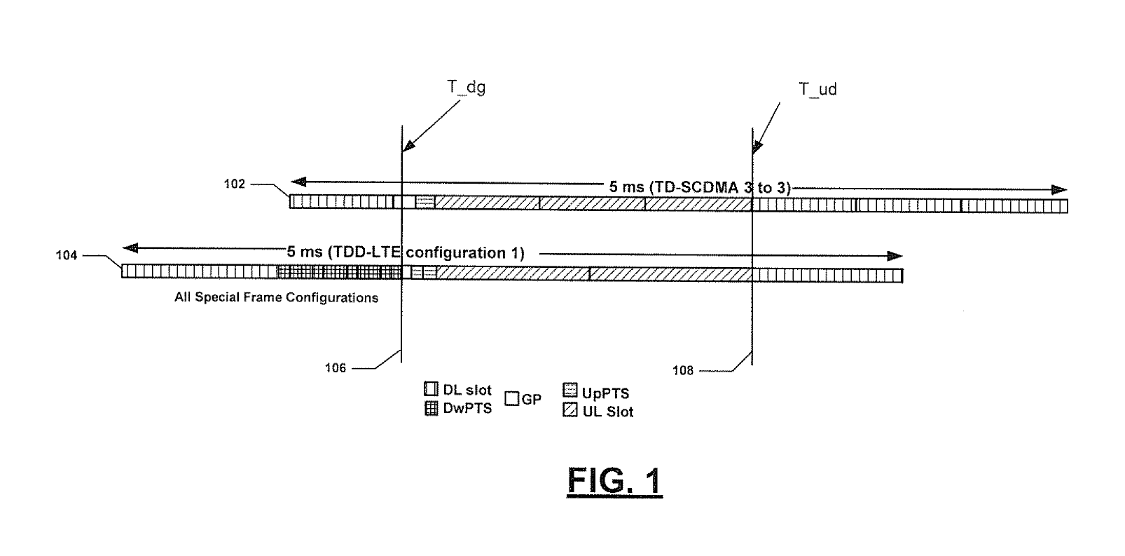

Referring now to FIG. 1, an example of a compatibility requirement for such co-deployed wireless networking technologies is illustrated. More particularly, FIG. 1 illustrates a timing diagram showing alignment between a TD-SCDMA system 102 using a 3:3 UL/DL ratio and a TDD-LTE system 104. The TDD-LTE system 104 may use TDD configuration number 1 and a special subframe pattern (SSP) configuration with Downlink Pilot Time Slot (DwPTS):Guard Period (GP):Uplink Pilot Time Slot (UpPTS) of 11:1:2. In this regard, the TDD-LTE system 104 may be configured so that the DwPTS of the TDD-LTE system 104 does not overlap with the start of the GP of the TD-SCDMA system, at time T_dg 106. As illustrated in FIG. 1, the TDD-LTE system 104 does not have any downlink transmission until the start of the downlink slot of the TD-SCDMA system 102, at time T_ud 108, so as to avoid UL/DL interference.

Accordingly, an SSP configuration (e.g., 11:1:2 in the example of FIG. 1) may be selected that may facilitate UL/DL alignment between two co-deployed wireless networking technologies. Several such SSP configurations are defined in LTE Release 9, which are shown in Table 1, below:

| | Normal cyclic | | | Extended cyclic | | |
|---|---|---|---|---|---|---|
| | prefix in downlink | | | prefix in downlink | | |
| | | UpPTS | | | UpPTS | |
| | | Normal | | | Normal | |
| | | cyclic | Extended | | cyclic | Extended |
| Special subframe | | prefix | cyclic prefix | | prefix in | cyclic prefix in |
| configuration | DwPTS | in uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

Table 1 may be simplified to illustrate how many Orthogonal Frequency Division Multiplexing (OFDM) symbols are in each of the DwPTS, GP, and UpPTS domains. As such, the number of OFDM symbols for each domain of the SSP configurations are shown in Table 2, below:

| Special subframe | Normal CP | | | Extended CP | | |
|---|---|---|---|---|---|---|
| configuration | DwPTS | GP | UpPTS | DwPTS | GP | UpPTS |
| 0 | 3 | 10 | 1 | 3 | 8 | 1 |
| 1 | 9 | 4 | 1 | 8 | 3 | 1 |
| 2 | 10 | 3 | 1 | 9 | 2 | 1 |
| 3 | 11 | 2 | 1 | 10 | 1 | 1 |
| 4 | 12 | 1 | 1 | 3 | 7 | 2 |
| 5 | 3 | 9 | 2 | 8 | 2 | 2 |
| 6 | 9 | 3 | 2 | 9 | 1 | 2 |
| 7 | 10 | 2 | 2 | | | |
| 8 | 11 | 1 | 2 | | | |

The SSP configurations set forth in Table 2 will be referred to by way of example throughout this disclosure by reference to the configuration number in the table. For example, as set forth in Table 2, SSP configuration #5 may have a configuration pattern of DwPTS:GP=3:10:1. As another example, as set forth in Table 2, SSP configuration #0 may have a configuration pattern of DwPTS:GP=3:9:2.

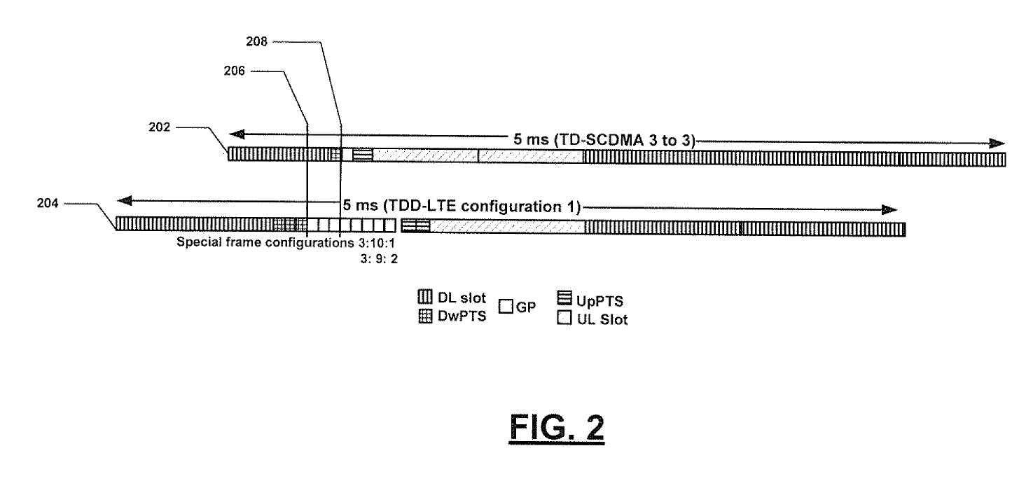

Usage of a TD-SCDMA configuration with a UL/DL ratio of 2:4 (1:3 in terms of traffic slot) may become increasingly prevalent in the future. In order to facilitate compatibility with such a TD-SCDMA configuration, a TDD LTE system may be configured to use UL/DL configuration #2 SSP configuration #0 or #5. FIG. 2 illustrates an example of such a configuration. Referring to FIG. 2, FIG. 2 illustrates an alignment between a TD-SCDMA system 202 using a 2:4 UL/DL ratio and a TDD-LTE system 204 using either SSP configuration #0 or SSP configuration #5. However, it may be seen that in the example of FIG. 2, available transmission resources for the TDD-LTE system 204 are wasted. More particularly, it may be seen that while usage of SSP configuration #0 or SSP configuration #5 avoids UL/DL interference with the TD-SCDMA system 202, there are three OFDM symbols available that may be used for additional DL transmission in the TDD-LTE system 204 without overlapping the GP and UL slots of the TD-SCDMA system 202. More particularly, it may be seen that three OFDM symbols are available between time 206 and the beginning of the GP of the TD-SCDMA system 202, at time 208.

As such, it may be advantageous to provide additional SSP configurations in addition to the nine SSP configurations listed in Table 2, which offer an extended DwPTS to enable usage of resources that may otherwise be wasted, such as illustrated in FIG. 2. In this regard, two additional SSP configurations may be defined that may, for example, be used in lieu of the SSP configurations illustrated in FIG. 2. These two additional SSP configurations are shown in Table 3, below:

| Special subframe | Normal CP | | | Extended CP | | |
|---|---|---|---|---|---|---|
| configuration | DwPTS | GP | UpPTS | DwPTS | GP | UpPTS |
| 9 | 6 | 6 | 2 | 5 | 5 | 2 |
| 10 | 6 | 7 | 1 | 5 | 6 | 1 |

Accordingly, newer and/or future UEs (e.g., new UEs) may be configured to use SSP configuration #s 9 and 10 in addition to the nine SSP configurations listed in Table 2. However, older and/or existing UEs (e.g., legacy UEs) may only be configured to use the nine SSP configurations listed in Table 2. As both new UEs configured to use SSP configuration #s 0-10 and legacy UEs configured to use only SSP configuration #s 0-8 may be used in the same cell, usage of SSP configuration #s 9 and 10 should be backwards compatible so that legacy UEs are not impacted. From Tables 2 and 3, it may be noted that there are two cases where multiplexing between a new UE and legacy UE operating in a same cell may be needed. In this regard, SSP configuration #5 (legacy UE) may be multiplexed with SSP configuration #9 (new UE), and SSP configuration #0 (legacy UE) may be multiplexed with SSP configuration #10 (new UE).

However, as not all UEs on a given cell may be capable of using SSP configuration #s 9 and 10, configuration of a UE with either SSP configuration #9 and #10 should be performed in a manner that does not impact the ability of legacy UEs on the cell to use SSP configuration #5 or SSP configuration #0. Accordingly broadcast by a network access point of a configuration of SSP configuration #9 or #10 may not provide for backward compatibility, because a legacy UE may not recognize the broadcast configuration information. In this regard, broadcast of an SSP configuration may only use one of SSP configuration #0-#8 since a legacy UE may not recognize SSP configuration #9 or #10.

As such, example embodiments are provided herein that facilitate configuration of SSP configurations, such as SSP configuration #9, #10, and/or the like that may not be usable by legacy UEs in a manner that allows for backwards compatibility with legacy UEs. More particularly, some example embodiments disclosed herein provide for the use of dedicated signaling to reconfigure a newer UE to use an alternative SSP configuration (E.g., SSP configuration #9 or #10) that may not be recognized by a legacy UE on the same cell, but that may be multiplexed with an SSP configuration used by the legacy UE.

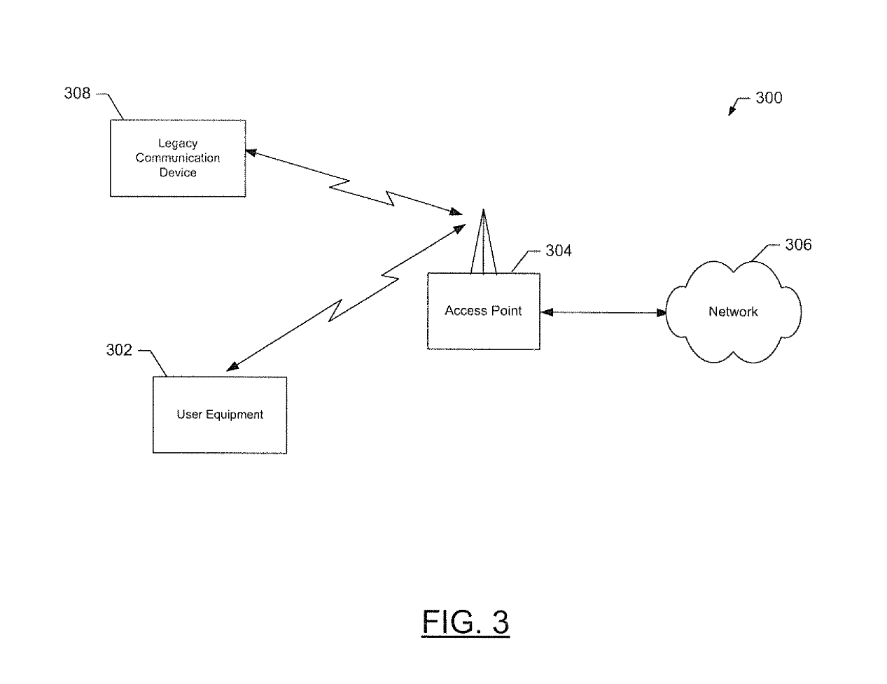

Referring now to FIG. 3, a block diagram of an example communication system 300 for SSP configuration in accordance with some example embodiments is illustrated. It will be appreciated that the system 300 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 3 illustrates one example of a configuration of a communication system for SSP configuration, numerous other configurations may also be used to implement embodiments of the present invention.

The system 300 may include an access point 304 that may provide wireless access to a network 306. The access point 306 may comprise any entity configured to provide radio access to the network 306 and configure a UE to use an SSP configuration in accordance with one or more example embodiments disclosed herein. By way of example, the access point 306 may comprise a base station, such as an evolved node B (eNB), node B, or other base station.

The network 306 may comprise one or more wireless networks (for example, a cellular network, wireless local area network, wireless personal area network, wireless metropolitan area network, and/or the like), one or more wireline networks, or some combination thereof, and in some embodiments may comprise at least a portion of the internet. In some example embodiments, the network 306 may employ one or more mobile access mechanisms, such as LTE, LTE-A, TDSCMA, wideband code division multiple access (W-CDMA), CDMA2000, global system for mobile communications (GSM), general packet radio service (GPRS), and/or the like. As such, it will be appreciated that where embodiments are described herein with respect to LTE and/or LTE-A systems, the use of LTE and/or LTE-A is by way of example and not by way of limitation. In this regard, example embodiments disclosed herein may be employed in accordance with any other wireless networking technology, protocol, or standard wherein an SSP configuration or the equivalent may be used.

In some example embodiments, the access point 304 may be configured to provide a UE 302 with wireless access to the network 306. The UE 302 may comprise any mobile communication device, such as, a mobile telephone, portable digital assistant (PDA), smart phone, pager, laptop computer, portable game device, or any of numerous other hand held or portable communication devices, computation devices, content generation devices, content consumption devices, or combinations thereof. It will be appreciated that although only a single UE 302 is illustrated in FIG. 3, the system 300 may include a plurality of UEs 302, which may access the network 306 through the access point 304.

The system 300 may additionally include one or more legacy communication devices 308. A legacy communication device 308 may comprise a mobile communication device (e.g., a UE), which may only be capable of using a subset of the SSP configurations that the UE 302 is capable of using. For example, a legacy communication device 308 may only be capable of using SSP configuration #s 0-8, while a UE 302 may be capable of using SSP configuration #s 9 and 10 in addition to SSP configuration #s 0-8. In this regard, a legacy communication device 308 may, for example, comprise an LTE Release 9 (or prior) mobile terminal, while a UE 302 may, for example, comprise an LTE Release 11 (or later) mobile terminal.

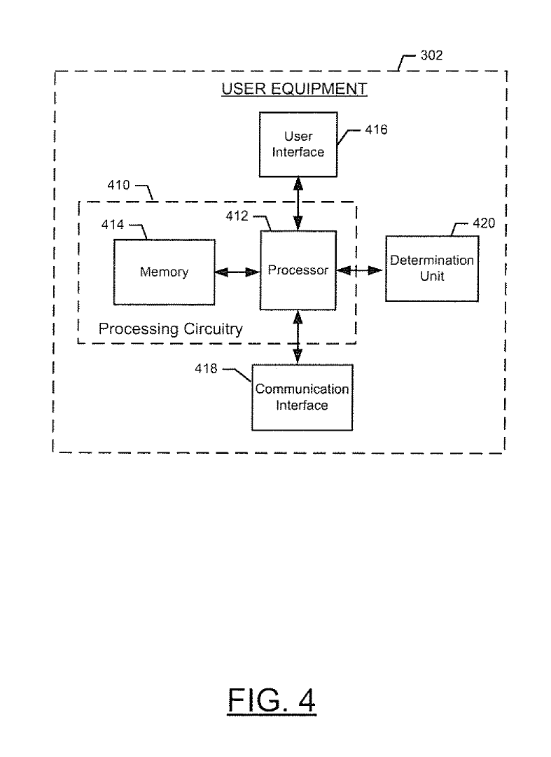

FIG. 4 illustrates a schematic block diagram of a UE 302 in accordance with some example embodiments. In this regard, FIG. 4 illustrates an apparatus that may comprise or be employed on a UE 302, and which may be configured to perform at least some of the functionality of a UE 302 as described herein. However, it should be noted that the components, devices or elements illustrated in and described with respect to FIG. 4 below may not be mandatory and thus some may be omitted in certain embodiments. Additionally, some embodiments may include further or different components, devices or elements beyond those illustrated in and described with respect to FIG. 4.

Referring now to FIG. 4, the UE 302 may include or otherwise be in communication with processing circuitry 410 that is configurable to perform actions in accordance with example embodiments disclosed herein. The processing circuitry 410 may be configured to perform data processing, application execution and/or other processing and management services according to one or more example embodiments. In some embodiments, the UE 302 or the processing circuitry 410 may be embodied as or comprise a chip or chip set. In other words, the UE 302 or the processing circuitry 410 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The UE 302 or the processing circuitry 410 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 410 may include a processor 412 and, in some embodiments, such as that illustrated in FIG. 4, may further include memory 414. The processing circuitry 410 may be in communication with or otherwise control a user interface 416 and/or a communication interface 418. As such, the processing circuitry 410 may be embodied as a circuit chip (e.g., an integrated circuit chip) configured (e.g., with hardware, software or a combination of hardware and software) to perform operations described herein.

The user interface 416 (if implemented) may be in communication with the processing circuitry 410 to receive an indication of a user input at the user interface 416 and/or to provide an audible, visual, mechanical or other output to the user. As such, the user interface 416 may include, for example, a keyboard, a mouse, a joystick, a display, a touch screen, a microphone, a speaker, and/or other input/output mechanisms.

The communication interface 418 may include one or more interface mechanisms for enabling communication with other devices and/or networks. In some cases, the communication interface 418 may be any means such as a device or circuitry embodied in either hardware, or a combination of hardware and software that is configured to receive and/or transmit data from/to a network and/or any other device or module in communication with the processing circuitry 410. By way of example, the communication interface 418 may be configured to enable radio access of the network 306 by way of the access point 304. In this regard, the communication interface 418 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In some example embodiments, the memory 414 may include one or more non-transitory memory devices such as, for example, volatile and/or non-volatile memory that may be either fixed or removable. The memory 414 may be configured to store information, data, applications, instructions or the like for enabling the UE 302 to carry out various functions in accordance with one or more example embodiments. For example, the memory 414 may be configured to buffer input data for processing by the processor 412. Additionally or alternatively, the memory 414 may be configured to store instructions for execution by the processor 412. As yet another alternative, the memory 414 may include one or more databases that may store a variety of files, contents or data sets. Among the contents of the memory 414, applications may be stored for execution by the processor 412 in order to carry out the functionality associated with each respective application. In some cases, the memory 414 may be in communication with the processor 412 via a bus for passing information among components of the user equipment 302.

The processor 412 may be embodied in a number of different ways. For example, the processor 412 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In some example embodiments, the processor 412 may be configured to execute instructions stored in the memory 414 or otherwise accessible to the processor 412. As such, whether configured by hardware or by a combination of hardware and software, the processor 412 may represent an entity (e.g., physically embodied in circuitry—in the form of processing circuitry 410) capable of performing operations according to embodiments of the present invention while configured accordingly. Thus, for example, when the processor 412 is embodied as an ASIC, FPGA or the like, the processor 412 may be specifically configured hardware for conducting the operations described herein. Alternatively, as another example, when the processor 412 is embodied as an executor of software instructions, the instructions may specifically configure the processor 412 to perform one or more operations described herein.

In an example embodiment, the processor 412 (or the processing circuitry 410) may be embodied as, include, or otherwise control a determination unit 420. As such, the determination unit 420 may be embodied as various means, such as circuitry, hardware, a computer program product comprising computer readable program instructions stored on a computer readable medium (for example, the memory 414) and executed by a processing device (for example, the processor 412), or some combination thereof. The determination unit 420 may be capable of communication with one or more of the memory 414, user interface 416, or communication interface 418 to access, receive, and/or send data as may be needed to perform one or more of the functionalities of the determination unit 420 as described herein.

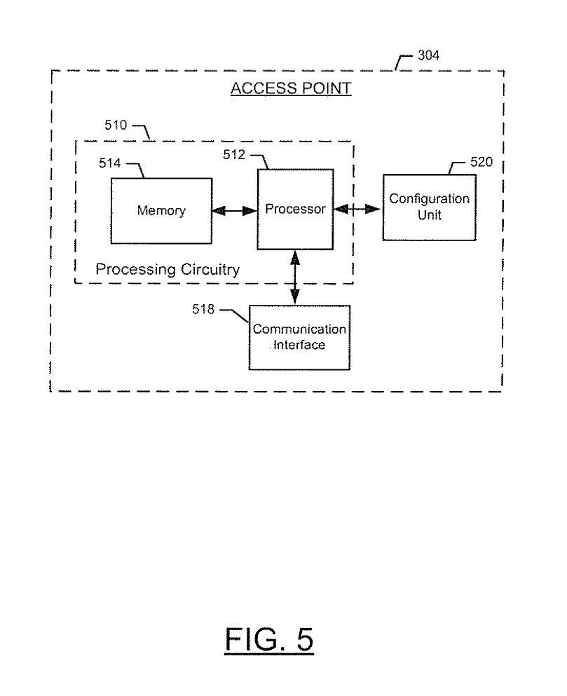

FIG. 5 illustrates a schematic block diagram of an access point 304 in accordance with some example embodiments. In this regard, FIG. 5 illustrates an apparatus that may comprise or be employed on an access point 304, and which may be configured to perform at least some of the functionality of an access point 304 as described herein. However, it should be noted that the components, devices or elements illustrated in and described with respect to FIG. 5 below may not be mandatory and thus some may be omitted in certain embodiments. Additionally, some embodiments may include further or different components, devices or elements beyond those illustrated in and described with respect to FIG. 5.

Referring now to FIG. 5, the access point 304 may include or otherwise be in communication with processing circuitry 510 that is configurable to perform actions in accordance with example embodiments disclosed herein. The processing circuitry 510 may be configured to perform data processing, application execution and/or other processing and management services according to one or more example embodiments. In some embodiments, the access point 304 or the processing circuitry 510 may be embodied as or comprise a chip or chip set. In other words, the access point 304 or the processing circuitry 510 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The access point 304 or the processing circuitry 510 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 510 may include a processor 512 and, in some embodiments, such as that illustrated in FIG. 4, may further include memory 514. The processing circuitry 510 may be in communication with or otherwise control a communication interface 518. As such, the processing circuitry 510 may be embodied as a circuit chip (e.g., an integrated circuit chip) configured (e.g., with hardware, software or a combination of hardware and software) to perform operations described herein. However, in some embodiments, the processing circuitry 510 may be embodied as a portion of a server, computer, workstation or other fixed or mobile computing device.

The communication interface 518 may include one or more interface mechanisms for enabling communication with other devices and/or networks. In some cases, the communication interface 518 may be any means such as a device or circuitry embodied in either hardware, or a combination of hardware and software that is configured to receive and/or transmit data from/to a network and/or any other device or module in communication with the processing circuitry 510. By way of example, the communication interface 518 may enable sending and/or receiving data to and/or from another device over the network 306. As another example, the communication interface 518 may enable sending and/or receiving data to and/or from a UE 302 and/or a legacy communication device 308 over a radio interface. In this regard, the communication interface 518 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In some example embodiments, the memory 514 may include one or more non-transitory memory devices such as, for example, volatile and/or non-volatile memory that may be either fixed or removable. The memory 514 may be configured to store information, data, applications, instructions or the like for enabling the access point 304 to carry out various functions in accordance with one or more example embodiments. For example, the memory 514 may be configured to buffer input data for processing by the processor 512. Additionally or alternatively, the memory 514 may be configured to store instructions for execution by the processor 512. As yet another alternative, the memory 514 may include one or more databases that may store a variety of files, contents or data sets. Among the contents of the memory 514, applications may be stored for execution by the processor 512 in order to carry out the functionality associated with each respective application. In some cases, the memory 514 may be in communication with the processor 512 via a bus for passing information among components of the access point 304.

The processor 512 may be embodied in a number of different ways. For example, the processor 512 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In some example embodiments, the processor 512 may be configured to execute instructions stored in the memory 514 or otherwise accessible to the processor 512. As such, whether configured by hardware or by a combination of hardware and software, the processor 512 may represent an entity (e.g., physically embodied in circuitry—in the form of processing circuitry 510) capable of performing operations according to embodiments of the present invention while configured accordingly. Thus, for example, when the processor 512 is embodied as an ASIC, FPGA or the like, the processor 512 may be specifically configured hardware for conducting the operations described herein. Alternatively, as another example, when the processor 512 is embodied as an executor of software instructions, the instructions may specifically configure the processor 512 to perform one or more operations described herein.

In an example embodiment, the processor 512 (or the processing circuitry 510) may be embodied as, include, or otherwise control a configuration unit 520. As such, the configuration unit 520 may be embodied as various means, such as circuitry, hardware, a computer program product comprising computer readable program instructions stored on a computer readable medium (for example, the memory 514) and executed by a processing device (for example, the processor 512), or some combination thereof. The configuration unit 520 may be capable of communication with one or more of the memory 514 or communication interface 518 to access, receive, and/or send data as may be needed to perform one or more of the functionalities of the configuration unit 520 as described herein.

In some example embodiments, the configuration unit 520 may be configured to cause the access point 304 to signal a configuration of an SSP configuration (e.g., a primary SSP configuration) to one or more UEs 302 and/or one or more legacy communication devices 308 that may be connected to and/or within range of the access point 304. As an example, the configuration unit 520 may cause the access point 304 to broadcast the configuration of the primary SSP configuration, such as in a system information block type 1 (SIB-1). As another example, the configuration unit 520 may cause the access point to transmit the configuration of the primary SSP configuration to each of one or more UEs 302 and/or one or more legacy communication devices 308 in a handover (HO) command. The primary SSP configuration signaled by the access point 304 may comprise an SSP configuration that may be recognized and used by both legacy communication devices 308 and UEs 302, such as, for example, SSP configuration #0 or SSP configuration #5. The signaled primary SSP configuration may have a corresponding secondary SSP configuration that is configured for multiplexing with the signaled primary SSP configuration. The corresponding secondary SSP configuration may, for example, offer an extended DwPTS time slot compared to the previously signaled primary SSP configuration, which may use resources, such as illustrated in the example of FIG. 2, which might be wasted if the signaled primary SSP configuration is used. For example, if SSP configuration #0 is signaled as the primary SSP configuration, the corresponding secondary SSP configuration may be SSP configuration #10. As another example, if SSP configuration #5 is signaled as the primary SSP configuration, the corresponding secondary SSP configuration may be SSP configuration #9.

Following signaling of the primary SSP configuration, the configuration unit 520 may be configured to cause the access point 304 to signal a downlink assignment to one or more UEs 302. The downlink assignment may, for example, comprise a dynamic downlink assignment, a semi-persistent scheduling downlink assignment, or the like. As an example, the configuration unit 520 may be configured to signal a downlink assignment to a UE 302 in a DwPTS that follows signaling of the configuration of the primary SSP configuration (e.g., an SSP configuration broadcast in a SIB-1). Signaling of the downlink assignment may trigger a capable terminal (e.g., a UE 302) to use a secondary SSP configuration corresponding to the signaled primary SSP configuration rather than the signaled primary SSP configuration, as will be described further herein below. Accordingly, for example, if SSP configuration #0 had been previously signaled, signaling of the downlink assignment may trigger a UE 302 to use SSP configuration #10 instead of SSP configuration #0. As another example, if SSP configuration #5 had been previously signaled, signaling of the downlink assignment may trigger a UE 302 to use SSP configuration #9 instead of SSP configuration #5.

In some example embodiments, the configuration unit 520 may be configured to cause signaling of the downlink assignment only to a terminals) (e.g., a UE(s) 302) that is capable of using a secondary SSP configuration (e.g., SSP configuration #9 and/or SSP configuration #10) corresponding to the signaled primary SSP configuration (e.g., SSP configuration #0 or SSP configuration #5). In this regard, the configuration unit 520 may be configured to determine capability information for a terminal and determine whether the terminal is capable of using a secondary SSP configuration (e.g., SSP configuration #9 and/or SSP configuration #10), corresponding to the previously signaled primary SSP configuration (e.g., SSP configuration #0 or SSP configuration #5). For example, the configuration unit 520 may be configured to determine LTE release information for a terminal, and if the release information for the terminal is LTE Release 11 or beyond, the configuration unit 520 may determine that the terminal is capable of using a secondary SSP configuration (e.g., SSP configuration #9 and/or SSP configuration #10) corresponding to the signaled primary SSP configuration (e.g., SSP configuration #0 or SSP configuration #5). The capability information (e.g., LTE release information or the like) for a terminal may, for example, be signaled to the access point 304 by the terminal.

The determination unit 420 may be configured to determine a configuration of a primary SSP configuration signaled by the access point 304. Accordingly, for example, the determination unit 420 may be configured to determine an SSP configuration broadcast by the access point 304, such as in a SIB-1. As another example, the determination unit 420 may be configured to determine an SSP configuration signaled in a HO command.

The determination unit 420 may be configured to determine whether the signaled primary SSP configuration is a configuration having a corresponding secondary SSP configuration configured for multiplexing with the signaled primary SSP configuration. Such a corresponding secondary SSP configuration may, for example, offer an extended DwPTS compared to the signaled SSP configuration. In this regard, the determination unit may, for example, determine whether the signaled primary SSP configuration is SSP configuration #0 or SSP configuration #5. If the determination unit 420 determines that the signaled primary SSP configuration does not have a corresponding secondary SSP configuration, the determination unit 420 may use the signaled primary SSP configuration. If, however, the determination unit 420 determines that the signaled primary SSP configuration does have a corresponding secondary SSP configuration, the determination unit 420 may use the signaled primary SSP configuration at least temporarily, but may monitor for a downlink assignment in response to determining that the signaled primary SSP configuration has a corresponding secondary SSP configuration. As an example, the determination unit 420 may monitor for signaling of a downlink assignment in a DwPTS following signaling of the primary SSP configuration.

If a downlink assignment is not detected, the determination unit 420 may determine to use the previously signaled primary SSP configuration. If, however, a downlink assignment is detected, the determination unit 420 may determine to use the corresponding secondary SSP configuration instead of the signaled primary SSP configuration in response to detection of the downlink assignment. Accordingly, for example, if the signaled primary SSP configuration was SSP configuration #0 and a downlink assignment is detected, the determination unit 420 may determine to use SSP configuration #10 instead of SSP configuration #0. As another example, if the signaled primary SSP configuration was SSP configuration #5, the determination unit 420 may determine to use SSP configuration #9 instead of SSP configuration #5.

In an instance in which a dynamic downlink assignment is detected, the determination unit 420 may determine to use the secondary SSP configuration only for a current special subframe. If, however, a semi-persistent downlink assignment is detected, the determination unit 420 may deter mine to use the secondary SSP configuration until the resource is released (e.g., by the access point). In this regard, the UE 302 may receive/transmit (e.g., periodically receive/transmit) data on the same time-frequency resource according to the scheduling information contained in the semi-persistent scheduling PDCCH until release of the resource.

The configuration unit 520 may be further configured to cause the access point 304 to transmit data via a physical downlink shared channel (PDSCH) and/or to transmit a cell specific reference symbol(s) (CRS) in accordance with the corresponding secondary SSP configuration pattern to a UE 302 using a configuration pattern of the secondary SSP in lieu of the configuration pattern of the signaled primary SSP. In this regard, the configuration unit 520 may be configured to cause transmission of data via a PDSCH and/or of CRS(s) to the UE 302 in accordance with the corresponding SSP configuration, which may offer an extended DwPTS compared to the originally signaled SSP configuration.

Accordingly, the determination unit 420 may be configured, responsive to the downlink assignment, to further assume that downlink PDSCH may be presented in the current subframe. The determination unit 420 may further monitor for CRS, which may be presented in accordance with the secondary SSP configuration used in response to the downlink assignment. Accordingly, for example, if SSP configuration #9 or SSP configuration #10 is used, the determination unit may monitor for CRS on OFDM symbol #4 (for normal configuration pattern) or #3 (for extended configuration pattern), whereas it may have been assumed that there would be no downlink transmission on that symbol if SSP configuration #0 or SSP configuration #10 had been used. Thus, resources that otherwise may have been wasted may be used for further downlink transmission in accordance with some example embodiments. In other embodiments, the determination unit 420 may be configured to monitor for CRS transmission in accordance with a secondary SSP configuration in any instance in which the signaled primary SSP configuration has a corresponding secondary SSP configuration, but may only regard a received CRS as a reference only in an instance in which a downlink assignment has been received.

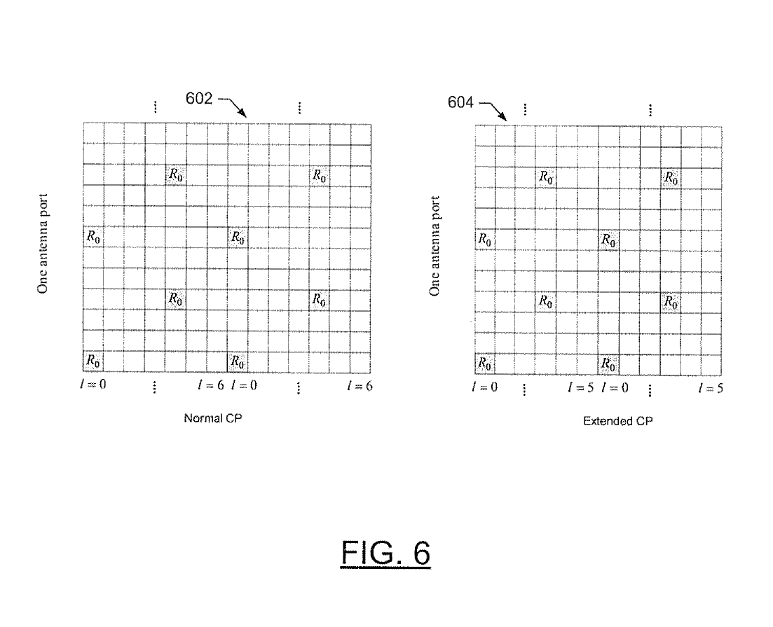

An example may be seen in FIG. 6, which illustrates an example cell reference signal pattern for a single antenna port using a normal configuration pattern 602 and an extended configuration pattern 604. In this regard, the number of available CRS may vary with the length of DwPTS in the special subframe. For example, if the length of DwPTS is 3, only 2 CRS may be available, but if the length of DwPTS is 5, 4 CRS may be available. Accordingly, the number of CRS assumed by the determination unit 420 may depend on whether the DL assignment is received (e.g., whether the determination unit 420 uses the primary or a secondary SSP configuration).

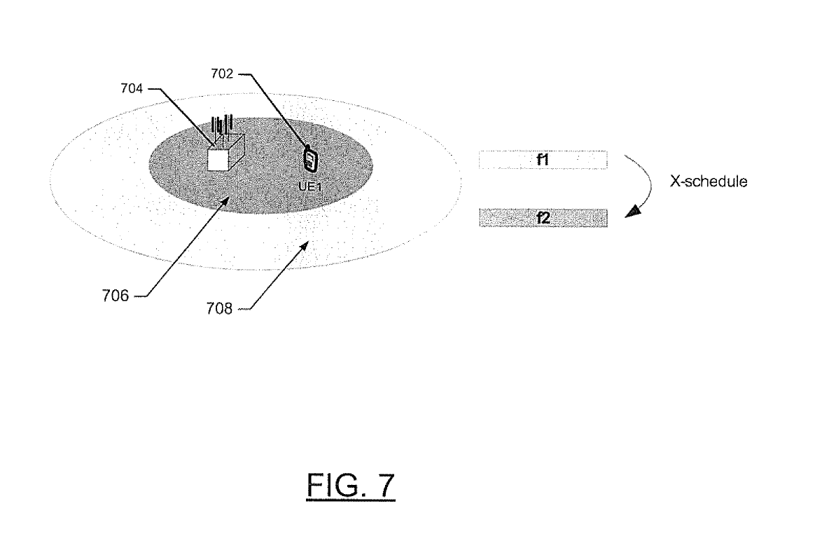

Some example embodiments may be applied in an instance in which a second cell is cross carrier scheduled from a first cell (e.g., a carrier aggregation scenario). An example of this scenario is illustrated in FIG. 7. In this regard, an access point 704 may be associated with a first cell 706. However, the access point 704 may be configured to schedule the UE 702 on the second cell 708 from the first cell 706. The UE 702 may accordingly be configured for carrier aggregation and may be scheduled for the second cell 708 by the access point 704. The UE 702 may, for example, comprise an embodiment of the UE 302, and the access point 704 may, for example, comprise an embodiment of the access point 304. In some such embodiments, the determination unit 420 may accordingly be configured, in response to signaling by the access point 704 of a configuration of an SSP configuration having a defined corresponding SSP configuration and of a subsequent cross carrier scheduling downlink assignment for the second cell, to use the corresponding SSP configuration in the second cell instead of the signaled SSP configuration. The determination unit 420 may further be configured to assume that downlink PDSCH is presented in a current subframe on the second cell, even if the previous configuration of the second cell does not support a PDSCH transmission. Additionally, the determination unit 420 may monitor for a CRS transmission on the second cell in accordance with the corresponding SSP configuration used in lieu of the signaled SSP configuration in response to the downlink assignment for the second cell.

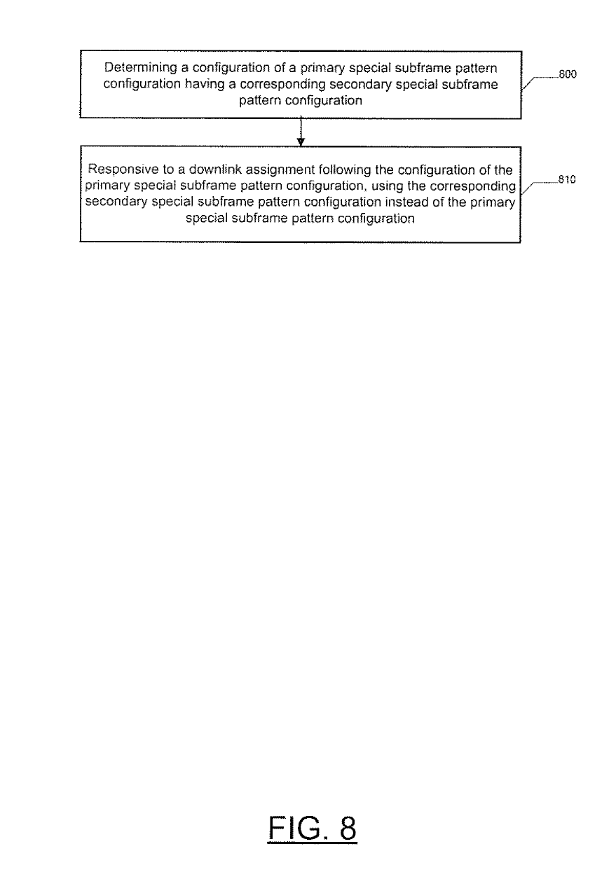

FIG. 8 illustrates a flowchart according to an example method for configuration of a special subframe pattern configuration according to some example embodiments. In this regard, FIG. 8 illustrates operations that may be performed at the UE 302. The operations illustrated in and described with respect to FIG. 8 may, for example, be performed by, with the assistance of, and/or under the control of one or more of the processing circuitry 410, processor 412, memory 414, communication interface 418, user interface 416, or determination unit 420. Operation 800 may comprise determining a configuration of a primary SSP configuration. The primary SSP configuration may have a defined corresponding SSP configuration. The processing circuitry 410, processor 412, memory 414, communication interface 418, and/or determination unit 420 may, for example, provide means for performing operation 800. Operation 810 may comprise, responsive to a downlink assignment following the configuration of the primary SSP configuration, using the corresponding SSP configuration instead of the primary SSP configuration. The processing circuitry 410, processor 412, memory 414, communication interface 418, and/or determination unit 420 may, for example, provide means for performing operation 810.

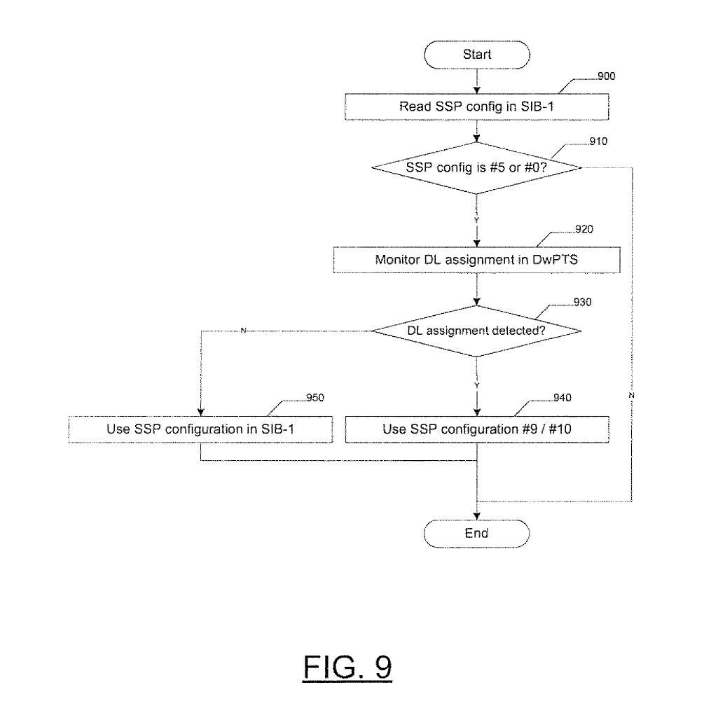

FIG. 9 illustrates a flowchart according to another example method for configuration of a special subframe pattern configuration according to some example embodiments. In this regard, FIG. 9 illustrates operations that may be performed at the UE 302. The operations illustrated in and described with respect to FIG. 9 may, for example, be performed by, with the assistance of, and/or under the control of one or more of the processing circuitry 410, processor 412, memory 414, communication interface 418, user interface 416, or determination unit 420. Operation 900 may comprise reading an SSP configuration, such as may be broadcast in SIB-1. The processing circuitry 410, processor 412, memory 414, communication interface 418, and/or determination unit 420 may, for example, provide means for performing operation 900. Operation 910 may comprise determining whether the SSP configuration read in operation 900 has a corresponding SSP configuration. In this regard, operation 910 may comprise determining whether the SSP configuration read in operation 900 is SSP configuration #0 or SSP configuration #5. The processing circuitry 410, processor 412, memory 414, and/or determination unit 420 may, for example, provide means for performing operation 910.

If it is determined that the SSP configuration read in operation 900 does not have a corresponding SSP configuration, the SSP configuration read in operation 900 may be used. If, however, it is determined that the SSP configuration read in operation 900 does have a corresponding SSP configuration, operation 920 may comprise monitoring for a downlink assignment in DwPTS and operation 930 may comprise determining whether a downlink assignment was detected. The processing circuitry 410, processor 412, memory 414, communication interface 418, and/or determination unit 420 may, for example, provide means for performing operations 920 and 930. If a downlink assignment was detected, then operation 940 may comprise using the corresponding SSP configuration rather than the SSP configuration read in operation 900. Accordingly, for example, if SSP configuration #5 was read in operation 900, operation 940 may comprise using SSP configuration #9 (e.g., an SSP configuration having a Downlink Pilot Time Slot:Guard Period:Uplink Pilot Time Slot configuration of 6:6:2 for a normal configuration pattern and a Downlink Pilot Time Slot:Guard Period:Uplink Pilot Time Slot configuration of 5:5:2 for an extended configuration pattern) instead of SSP configuration #5. As another example, if SSP configuration #0 was read in operation 900, operation 940 may comprise using SSP configuration #10 (e.g., an SSP configuration having a Downlink Pilot Time Slot:Guard Period:Uplink Pilot Time Slot configuration of 6:7:1 for a normal configuration pattern and a Downlink Pilot Time Slot:Guard Period:Uplink Pilot Time Slot configuration of 5:6:1 for an extended configuration pattern) instead of SSP configuration #0. The processing circuitry 410, processor 412, memory 414, communication interface 418, and/or determination unit 420 may, for example, provide means for performing operation 940. If, however, a downlink assignment was not detected, operation 950 may comprise using the SSP configuration read in operation 900. The processing circuitry 410, processor 412, memory 414, communication interface 418, and/or determination unit 420 may, for example, provide means for performing operation 950.

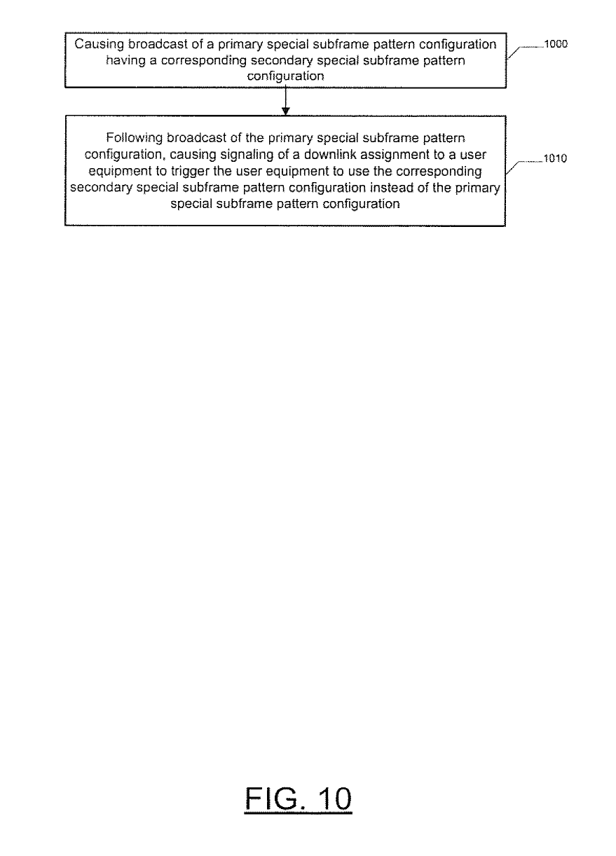

Referring now to FIG. 10, FIG. 10 illustrates a flowchart according to another example method for configuration of a special subframe pattern configuration according to some example embodiments. In this regard, FIG. 10 illustrates operations that may be performed at the access point 304. The operations illustrated in and described with respect to FIG. 10 may, for example, be performed by, with the assistance of, and/or under the control of one or more of the processing circuitry 510, processor 512, memory 514, communication interface 518, or configuration unit 520. Operation 1000 may comprise causing broadcast of a primary SSP configuration. The primary SSP configuration may have a defined corresponding SSP configuration. The processing circuitry 510, processor 512, memory 514, communication interface 518, and/or configuration unit 520 may, for example, provide means for performing operation 1000. Following broadcast of the primary special subframe pattern configuration, operation 1010 may comprise causing signaling of a downlink assignment to a user equipment to trigger the user equipment to use the corresponding SSP configuration instead of the primary SSP configuration. The processing circuitry 510, processor 512, memory 514, communication interface 518, and/or configuration unit 520 may, for example, provide means for performing operation 1010.

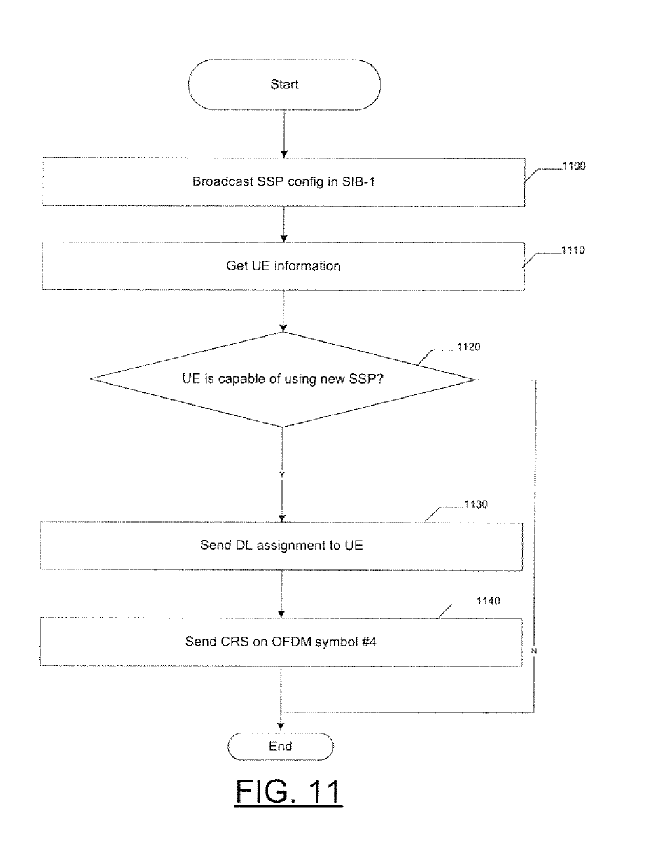

Referring now to FIG. 11, FIG. 11 illustrates a flowchart according to another example method for configuration of a special subframe pattern configuration according to some example embodiments. In this regard, FIG. 11 illustrates operations that may be performed at the access point 304. The operations illustrated in and described with respect to FIG. 11 may, for example, be performed by, with the assistance of, and/or under the control of one or more of the processing circuitry 510, processor 512, memory 514, communication interface 518, or configuration unit 520. Operation 1100 may comprise broadcasting an SSP configuration, such as in SIB-1. The broadcast SSP configuration may have a defined corresponding SSP configuration. In this regard, the broadcast SSP configuration may, for example, comprise SSP configuration #0 or SSP configuration #5. The processing circuitry 510, processor 512, memory 514, communication interface 518, and/or configuration unit 520 may, for example, provide means for performing operation 1100. Operation 1110 may comprise obtaining information for a user equipment (e.g., a UE 302). The processing circuitry 510, processor 512, memory 514, communication interface 518, and/or configuration unit 520 may, for example, provide means for performing operation 1110. Operation 1120 may comprise determining whether the UE is capable of using a new (e.g., the corresponding) SSP configuration. As an example, operation 1120 may comprise determining whether the UE is a Release 11 or later UE. The processing circuitry 510, processor 512, memory 514, and/or configuration unit 520 may, for example, provide means for performing operation 1120. If it is determined that the UE is not capable of using a new SSP configuration, the method may conclude. If, however, it is determined that the UE is capable of using a new SSP configuration, operation 1130 may comprise sending a downlink assignment to the UE to trigger the UE to use the corresponding SSP configuration rather than the SSP configuration broadcast in operation 1100. The processing circuitry 510, processor 512, memory 514, communication interface 518, and/or configuration unit 520 may, for example, provide means for performing operation 1130. Operation 1140 may comprise sending CRS in accordance with the corresponding SSP configuration, such as on OFDM symbol #4 (OFDM symbol #3 if an extended configuration pattern is used). The processing circuitry 510, processor 512, memory 514, communication interface 518, and/or configuration unit 520 may, for example, provide means for performing operation 1140.

FIGS. 8-11 are flowcharts of a system, method and program product according to example embodiments of the invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts block(s). These computer program instructions may also be stored in a non-transitory computer-readable storage memory that may direct a computer or other programmable apparatus to function in a particular manner, such that the instructions stored in the computer-readable storage memory produce an article of manufacture the execution of which implements the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining a configuration of a primary special subframe pattern configuration, the primary special subframe pattern configuration having a corresponding secondary special subframe pattern configuration configured for multiplexing with the primary special subframe pattern configuration; and
responsive to a downlink assignment following the configuration of the primary special subframe pattern configuration, using the secondary special subframe pattern configuration instead of the primary special subframe pattern configuration.

2. The method of claim 1, further comprising:
responsive to determining the configuration of the primary special subframe pattern configuration, monitoring for a downlink assignment following the configuration of the primary special subframe pattern configuration;
in an instance in which a downlink assignment is not detected in a current special subframe, using the primary special subframe pattern configuration; and
in an instance in which a downlink assignment is detected in the current special subframe, using the secondary special subframe pattern configuration in response to detection of the downlink assignment.

3. The method of claim 1, wherein the secondary special subframe pattern configuration comprises an extended downlink pilot time slot compared to the primary special subframe pattern configuration.

4. The method of claim 1, wherein the primary special subframe pattern configuration comprises special subframe pattern configuration number five, and wherein the secondary special subframe pattern configuration comprises a special subframe pattern configuration having a Downlink Pilot Time Slot:Guard Period:Uplink Pilot Time Slot configuration of 6:6:2 for a normal configuration pattern and a Downlink Pilot Time Slot:Guard Period:Uplink Pilot Time Slot configuration of 5:5:2 for an extended configuration pattern.

5. The method of claim 1, wherein the primary special subframe pattern configuration comprises special subframe pattern configuration number zero, and wherein the secondary special subframe pattern configuration comprises a special subframe pattern having a Downlink Pilot Time Slot:Guard Period:Uplink Pilot Time Slot configuration of 6:7:1 for a normal configuration pattern and a Downlink Pilot Time Slot:Guard Period:Uplink Pilot Time Slot configuration of 5:6:1 for an extended configuration pattern.

6. The method of claim 1, wherein determining the configuration of the primary special subframe pattern configuration comprises determining a configuration of the primary special subframe pattern configuration signaled in one of a system information block type 1 (SIB-1) or a handover command, and wherein the downlink assignment is signaled in a downlink pilot time slot.

7. (canceled)

8. (canceled)

9. (canceled)

10. A computer program product comprising at least one computer-readable storage medium having computer-executable program code instructions stored therein, the computer-executable program code instructions comprising program code instructions configured to perform a method according to claim 1.

11. An apparatus comprising processing circuitry configured to at least:
determine a configuration of a primary special subframe pattern configuration, the primary special subframe pattern configuration having a corresponding secondary special subframe pattern configuration configured for multiplexing with the primary special subframe pattern configuration; and
responsive to a downlink assignment following the configuration of the primary special subframe pattern configuration, use the secondary special subframe pattern configuration instead of the primary special subframe pattern configuration.

12. The apparatus of claim 11, wherein the processing circuitry is further configured to:
responsive to determining the configuration of the primary special subframe pattern configuration, monitor for a downlink assignment following the configuration of the primary special subframe pattern configuration;
in an instance in which a downlink assignment is not detected in a current special subframe, use the primary special subframe pattern configuration; and
in an instance in which a downlink assignment is detected in the current subframe, use the secondary special subframe pattern configuration in response to detection of the downlink assignment.

13. The apparatus of claim 11, wherein the secondary special subframe pattern configuration comprises an extended downlink pilot time slot compared to the primary special subframe pattern configuration.

14. (canceled)

15. (canceled)

16. The apparatus of claim 11, wherein the processing circuitry is configured to determine the configuration of the primary special subframe pattern configuration at least in part by determining a configuration of the primary special subframe pattern configuration signaled in one of a system information block type 1 (SIB-1) or a handover command, and wherein the downlink assignment is signaled in a downlink pilot time slot.

17. (canceled)

18. (canceled)

19. (canceled)

20. The apparatus of claim 11, wherein the apparatus comprises or is embodied on a mobile terminal configured to access a cellular network.

21. A method comprising:
causing broadcast of a primary special subframe pattern configuration, the primary special subframe pattern configuration having a corresponding secondary special subframe pattern configuration configured for multiplexing with the primary special subframe pattern configuration; and
following broadcast of the primary special subframe pattern configuration, causing signaling of a downlink assignment to a user equipment to trigger the user equipment to use the secondary special subframe pattern configuration instead of the primary special subframe pattern configuration.

22. The method of claim 21, further comprising, following signaling of the downlink assignment, causing transmission of a cell specific reference symbol to the user equipment in accordance with the secondary special subframe pattern configuration.

23. The method of claim 21, further comprising:
determining whether the user equipment is capable of using the secondary special subframe pattern configuration; and
wherein causing signaling of the downlink assignment to the user equipment comprises causing signaling of the downlink assignment to the user equipment only in an instance in which it is determined that the user equipment is capable of using the secondary special subframe pattern configuration.

24. (canceled)

25. (canceled)

26. (canceled)

27. A computer program product comprising at least one computer-readable storage medium having computer-executable program code instructions stored therein, the computer-executable program code instructions comprising program code instructions configured to perform a method according to claim 21.

28. An apparatus comprising processing circuitry configured to at least:
cause broadcast of a primary special subframe pattern configuration, the primary special subframe pattern configuration having a corresponding secondary special subframe pattern configuration configured for multiplexing with the primary special subframe pattern configuration; and
following broadcast of the primary special subframe pattern configuration, cause signaling of a downlink assignment to a user equipment to trigger the user equipment to use the secondary special subframe pattern configuration instead of the primary special subframe pattern configuration.

29. The apparatus of claim 28, wherein the processing circuitry is further configured, following signaling of the downlink assignment, to cause transmission of a cell specific reference symbol to the user equipment in accordance with the secondary special subframe pattern configuration.

30. The apparatus of claim 28, wherein the processing circuitry is further configured to:
determine whether the user equipment is capable of using the secondary special subframe pattern configuration; and
wherein the processing circuitry is configured to cause signaling of the downlink assignment to the user equipment only in an instance in which it is determined that the user equipment is capable of using the secondary special subframe pattern configuration.

31. (canceled)

32. (canceled)

33. (canceled)

34. The apparatus of claim 28, wherein the apparatus comprises or is embodied on an access point for a cellular network.
